(19) United States
(12) Patent Application Publication
(10) Pub. No.: US 2018/0165628 A1
(43) Pub. Date: Jun. 14, 2018

(54) FLEXIBLE WI-FI SMART BASE

(71) Applicant: Govindaraju COIMBATORE KRISHNASWAMY, Milton (CA)

(72) Inventor: Govindaraju COIMBATORE KRISHNASWAMY, Milton (CA)

(21) Appl. No.: 15/834,141

(22) Filed: Dec. 7, 2017

Related U.S. Application Data
(60) Provisional application No. 62/432,408, filed on Dec. 9, 2016.

(51) Int. Cl. G06Q 10/08

(52) U.S. Cl. CPC G06Q 10/087

(57) ABSTRACT

The invention provides a smart base for inventory management. The smart base for inventory management includes a top unit configured for replaceably holding at least one object. A bottom unit is operably coupled to the top unit. The bottom unit is configured for operating the smart base. A real time inventory management system is also provided. The real time inventory management system includes a plurality of smart bases, an interface module coupled to the smart bases, a centrally located server operably coupled to the interface module and at least one display unit coupled to the centrally located server.

### COPYRIGHT INFORMATION

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATION

This application claims the benefit of U.S. Provisional Application No. 62/432,408, filed on Dec. 9, 2016.

### FIELD OF THE INVENTION

The invention relates generally to a base upon which food/commodity related bags, containers, boxes etc are placed, displayed or warehoused but more particularly to an improved smart base with Wi-Fi connectivity and a system for industrial and commercial inventory management.

### BACKGROUND OF THE INVENTION

Inventory management for industrial and commercial uses can be challenging, made more so when managing a large variety of produce, food stuff and commodities constantly entering and leaving the premises. Products also come in varying packaging such as cartons, sacks, bags, bundles, cans etc. which are constantly moved around and accessed based on orders coming in and room available in the warehouse or store room. In order to manage inventory, bar codes on pallets help identify them and placing them in specific areas of the warehouse enables workers to find them. However, in many cases, this inventory is constantly being moved around and/or staff on duty has difficulty finding them as they were repositioned by a previous shift. Furthermore, when one, a few or multiple bags, cartons or containers are removed from a pallet or shelf, it becomes increasingly difficult to predict the remaining quantity unless an accurate physical inventory control system is maintained. In some situations, loose quantities of a produce in the form of grain, powders, liquids etc. may be dispensed from a large container in small and varying quantities at a time. Maintaining accurate records of the quantities used, quantities remaining and the location of each Stock Keeping Unit, SKU, can often be challenging and time consuming. There hence exists a need for an improved method to manage inventory within a commercial and/or industrial setting regardless of how a product is packed, placed stored or dispensed.

### SUMMARY OF THE INVENTION

It is a main advantage of this invention to provide for a Wi-Fi connected smart base provided with either a full bridge or a combination of half bridge planar beam load cells, which measure the weight of the produce, goods, food stuff, liquids, grains, boxes, cans or commodities alike that are placed upon it. It is another advantage of this invention that it be provided with a real time locating system (RTLS) technology in the form of radio frequency (RF) communication and optical or acoustic tags instead of or in addition to RF. This allows the smart base to be tracked and located in real time within a warehouse environment provided with fixed reference points that receive wireless signals from tags to determine their location.

It is a further advantage of the invention that it maintains intelligent communication between itself and an application server (or cloud) via built-in Wi-Fi capability. An inbuilt Wi-Fi module communicates with a server and database via internet through an interface modem and a modem. Several smart bases can be configured to synchronously update weight related data, product identifier, time, date and battery level data in real time to a central server, computer and to users on their smart phones, computers, tablets etc. via the server or cloud.

Furthermore, a software application linked to a database on the application servers allows clients, suppliers, wholesalers, stockists and other users to access and view real time data such as store sales, reorder levels, consumption levels, current stock, minimum and maximum levels, battery levels and other data as per their specific requirements.

In order to do so, the invention is comprised of a top unit and a bottom unit that comprises a power source, planar beam load cell, an electronic circuit board comprising microprocessors, integrated circuits, RF tag(s), Wi-Fi module, battery management circuit, product location identifier, timer circuit and charging port.

Depending on the size of the top unit, a full bridge or half bridge or a combination of the two types of planar beam load cells are used in the bottom unit. Alternatively, a special type of load cell can be used depending on a customer's individual requirement.

The smart base is configured in the database using its unique identifier. A product is placed on the smart base and recorded in the database with the unique identifier. Any weight change thereafter is collected by the interface modem and sent to the database and application server along with product identifier, time, date and battery level data in real time. Several such smart bases can be configured with a variety of products such that any change in their weight sends the above data through the interface modem and modem to the application server and database. Similarly, any change in position of the smart base is tracked using the RF tags and fixed reference points to determine its location.

A smart application interface allows clients through their customer account to view collated real time data and reports from the application server and database using their smart phones, tablets or pc's. In addition, user defined reports can be generated for assessing consumption over a period of time, total calories used over a period of time, expected reorder is going to be.

The foregoing and other objects, features, and advantages of this invention will become more readily apparent from the following detailed description of a preferred embodiment with reference to the accompanying drawings, wherein the preferred embodiment of the invention is shown and described, by way of examples.

As will be realized, the invention is capable of other and different embodiments, and its several details are capable of modifications in various obvious respects, all without departing from the invention. For example, the invention can be made in varied sizes to suit different industrial applications. The invention could use lower power Bluetooth or the latest available technology instead of Wi-Fi to communicate and the size, shape and materials used be varied based on production and commercial preferences. Accordingly, the drawings and description are to be regarded as illustrative in nature, and not as restrictive.

### BRIEF DESCRIPTION OF THE DRAWINGS

So that the manner in which the recited features of the invention can be understood in detail, some of the embodiments are illustrated in the appended drawings. It is to be noted, however, that the appended drawings illustrate only typical embodiments of this invention and are therefore not to be considered limiting of its scope, for the invention may admit to other equally effective embodiments.

FIG. 1(a) illustrates a smart base for inventory management, according to an embodiment of the invention.

FIG. 1(b) illustrates an exploded view of the integrated smart base for inventory management, according to an embodiment of the invention.

FIG. 2 illustrates a real time inventory management system, according to an embodiment of the invention.

### DETAILED DESCRIPTION OF THE PREFERRED EMBODIMENT

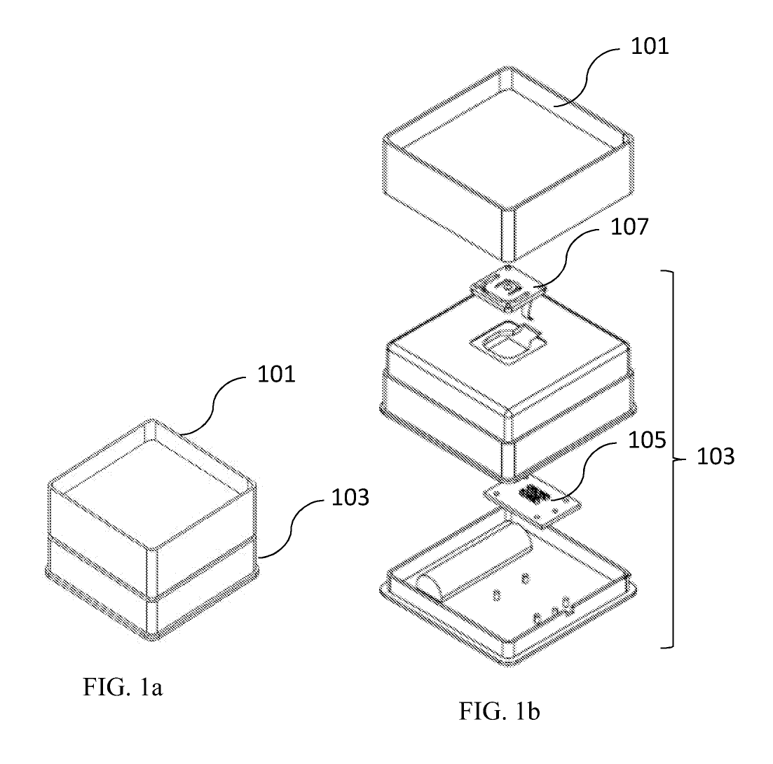

Aspects and embodiments relate generally to a smart base for industrial and commercial inventory management. FIG. 1(a) illustrates a smart base for inventory management, according to an embodiment of the invention. The smart base for inventory management includes a top unit 101 configured for replaceably holding at least one object. The object described herein includes but are not limited to cosmetics, groceries, food items, stationary, house-hold items, medicines, electronic appliances and industrial components. A bottom unit 103 is operably coupled to the top unit. The bottom unit is configured for operating the smart base.

FIG. 1(b) illustrates an exploded view of the smart base for inventory management, according to an embodiment of the invention. The bottom unit 103 includes a circuit 105. The circuit 105 includes a product location identifier, a weight detection module and a communication module. The product location identifier is configured for tracking the location of the smart base in real time. In one embodiment of the invention, the location is tracked by using a Real Time Locating System (RTLS) technology in the form of radio frequency (RF), optical and/or acoustic tags. This allows the smart base to be tracked and located in real time within a warehouse environment. The warehouse environment is provided with fixed reference points that receive wireless signals from tags to determine their location. In another embodiment of the invention, the location of the smart base is tracked by an audio and/or a visual indication unit. The weight detection module includes at least one load cell 107 for measuring the weight of the objects placed on the top unit 101. In one example of the invention, the load cell is a planar beam load cell. The planar beam load cell can be either half bridge or full bridge. The number of load cells is dependent on the size of the top unit. The communication module is configured for communicating a plurality of information with a display unit (Not shown). Examples of information include but are not limited to location of the smart base, weight of the objects, battery level, time and date. In one example of the invention, the display unit is an onboard display. Further, the bottom unit is provided with a power module for charging and/or operating the smart base.

An alternate embodiment of the invention provides an integrated smart base for inventory management. The integrated smart base is configured for replaceably holding at least one object. The object described herein includes but are not limited to cosmetics, groceries, food items, stationary, house-hold items, medicines, electronic appliances and industrial components. The integrated smart base includes a product location identifier, a weight detection module and a communication module. The product location identifier is configured for tracking the location of the smart base in real time. In one embodiment of the invention, the location is tracked by using a Real Time Locating System (RTLS) technology in the form of radio frequency (RF), optical and/or acoustic tags. This allows the smart base to be tracked and located in real time within a warehouse environment. The warehouse environment is provided with fixed reference points that receive wireless signals from tags to determine their location. In another embodiment of the invention, the location of the smart base is tracked by an audio and/or a visual indication unit. The weight detection module includes at least one load cell for measuring the weight of the objects, placed on the integrated smart base. In one example of the invention, the load cell is a planar beam load cell. The planar beam load cell can be either half bridge or full bridge. The number of load cells is dependent on the size of the top unit. The communication module is configured for communicating a plurality of information with a display unit. Examples of information include but are not limited to location of the smart base, weight of the objects, battery level, time and date. In one example of the invention, the display unit is an onboard display. Further, the integrated smart base is provided with a power module for charging and/or operating the integrated smart base.

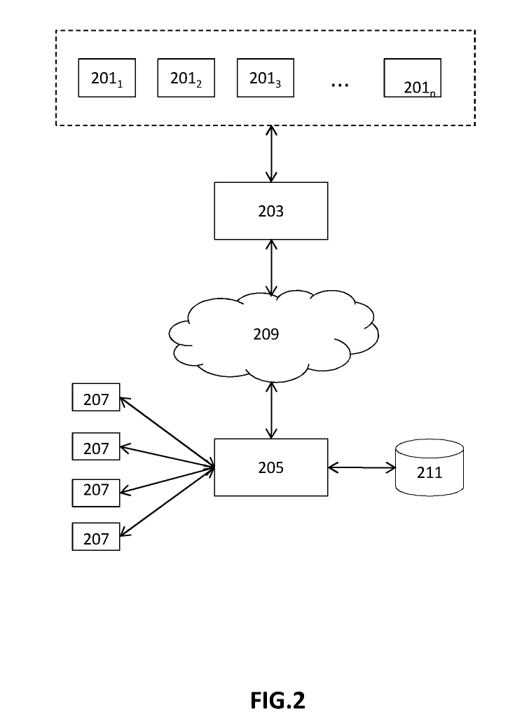

FIG. 2 illustrates a real time inventory management system, according to an embodiment of the invention. The real time inventory management system includes a plurality of smart bases 201₁, 201₂, 201₃ . . . 201ₙ, hereinafter referred to as smart bases 201, an interface module 203 coupled to the smart bases 201, a centrally located server 205 operably coupled to the interface module 203 and at least one display unit 207 coupled to the centrally located server 205. The system described hereinabove briefly shall be explained in detail.

The real time inventory management system includes a plurality of smart bases 201. The smart bases 201 are deployed within a premise. Examples of premise include but are not limited to a house, departmental store, a warehouse, a local mart, a super mart and a hyper mart. Each smart base 201 includes a top unit configured for replaceably holding at least one object. The object described herein includes but are not limited to cosmetics, groceries, food items, stationary, house-hold items, medicines, electronic appliances and industrial components. A bottom unit is operably coupled to the top unit. The bottom unit is configured for operating the smart base 201. The bottom unit includes a product location identifier, a weight detection module and a communication module. The product location identifier is configured for tracking the location of the smart base in real time. In one embodiment of the invention, the location is tracked by using a Real Time Locating System (RTLS) technology in the form of radio frequency (RF), optical and/or acoustic tags. This allows the smart base to be tracked and located in real time within a warehouse environment. The warehouse environment is provided with fixed reference points that receive wireless signals from tags to determine their location. In another embodiment of the invention, the location of the smart base is tracked by an audio and/or a visual indication unit. The weight detection module includes at least one load cell for measuring the weight of the objects placed on the top unit. In one example of the invention, the load cell is a planar beam load cell. The planar beam load cell can be either half bridge or full bridge. The number of load cells is dependent on the size of the top unit. The communication module is configured for communicating a plurality of information with a display unit. Examples of information include but are not limited to location of the smart base, weight of the objects, battery level, time and date. In one example of the invention, the display unit is an onboard display. Further, the bottom unit is provided with a power module for charging and/or operating the smart base.

The interface module 203 is configured for simultaneously receiving the information from the communication module of each of the smart bases 201. Further, the interface module 203 is configured for transferring the information to the centrally located server 205. The communication between each of the smart bases 201 and the server 205 is established through a wireless network 209. The wireless network 209 is at least one of a wi-fi network, a Bluetooth network, a near field communication network and/or a combination thereof. A database 211 is coupled to the server for retrievably storing the information.

The server 205 is configured for processing the information received from the smart bases 201. The server 205 is further configured for sending an alert to a user when the quantity of objects held on the top unit falls below a threshold. The user described herein includes but are not limited to a customer, a vendor, a supplier, a store manager, an owner, a wholesaler and a stockist.

The display unit 207 is coupled to the centrally located server 205. The display unit 207 is accessible from at least one device that includes but not limited to a mobile internet device, a computer, a smart phone, a notebook and a tablet. In one embodiment of the invention, the display unit 207 includes a software application. The database 211 coupled to the server 205 allows the user to access and view real time data such as store sales, reorder levels, consumption levels, current stock, minimum and maximum levels, battery levels and other data as per their specific requirements.

An alternate embodiment of the invention provides a real time inventory management system for integrated smart bases. The real time inventory management system includes a plurality of integrated smart bases, an interface module coupled to the integrated smart bases, a centrally located server operably coupled to the interface module and at least one display unit coupled to the centrally located server. The system described hereinabove briefly shall be explained in detail.

The real time inventory management system includes a plurality of integrated smart bases. The integrated smart bases are deployed within a premise. Examples of premise include but are not limited to a house, departmental store, a warehouse, a local mart, a super mart and a hyper mart. Each of the integrated smart bases is configured for replaceably holding at least one object. The object described herein includes but are not limited to cosmetics, groceries, food items, stationary, house-hold items, medicines, electronic appliances and industrial components. The integrated smart base includes a product location identifier, a weight detection module and a communication module. The product location identifier is configured for tracking the location of the smart base in real time. The location of the smart base is tracked by an audio and/or a visual indication unit. The weight detection module includes a load cell for measuring the weight of the objects placed on the integrated smart base. In one example of the invention, the load cell is a planar beam load cell. The planar beam load cell can be either half bridge or full bridge. The number of load cells is dependent on the size of the top unit. The communication module is configured for communicating a plurality of information with a display unit. Examples of information include but are not limited to location of the smart base, weight of the objects, battery level, time and date. In one example of the invention, the display unit is an onboard display. Further, the integrated smart base is provided with a power module for charging and/or operating the integrated smart base.

The interface module is configured for simultaneously receiving the information from the communication module of each of the integrated smart bases. Further, the interface module is configured for transferring the information to the centrally located server. The communication between each of the integrated smart bases and the server is established through a wireless network. The wireless network is at least one of a wi-fi network, a Bluetooth network, a near field communication network and/or a combination thereof. A database is coupled to the server for retrievably storing the information. The server is configured for processing the information received from the integrated smart bases. The server is further configured for sending an alert to a user when the weight of the objects held on the integrated smart base falls below a threshold. The user described herein includes but are not limited to a customer, a vendor, a supplier, a store manager, an owner, a wholesaler and a stockist.

The display unit is coupled to the centrally located server. The display unit is accessible from at least one device that includes but not limited to a mobile internet device, a computer, a smart phone, a notebook and a tablet. In one embodiment of the invention, the display unit includes a software application linked to a database 211 allows the user to access and view real time data such as store sales, reorder levels, consumption levels, current stock, minimum and maximum levels, battery levels and other data as per their specific requirements.

The above description is merely illustrative. Having thus described several aspects of at least one embodiment of this invention including the preferred embodiments, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

I claim:

1. A smart base for inventory management, the base comprising:
a top unit configured for replaceably holding at least one object; and
a bottom unit operably coupled to the top unit, wherein the bottom unit is configured for operating the smart base.

2. The smart base according to claim 1, wherein the object is selected from a list comprising of cosmetics, groceries, food items, stationary, house-hold items, medicines, electronic appliances and industrial components.

3. The smart base according to claim 1, wherein the bottom unit comprises of a product location identifier;
a weight detection module; and
a communication module.

4. The smart base according to claim 1, wherein the bottom unit is further provided with a power module for charging and/or operating the smart base.

5. The smart base according to claim 3, wherein the product location identifier is configured for tracking the location of the smart base in real time.

6. The smart base according to claim 5, wherein the location of the smart base is tracked by a Real Time Locating System, an audio and/or a visual indication unit.

7. The smart base according to claim 3, wherein the weight detection module comprises of at least one load cell for measuring the weight of the object placed on the top unit.

8. The smart base according to claim 3, wherein the communication module is configured for communicating a plurality of information selected from a list comprising of location of smart base, weight of object, battery level, time and date.

9. The smart base according to claim 3, wherein additionally a display unit is coupled to the communication module.

10. A real time inventory management system, the system comprising:
a plurality of smart bases;
an interface module coupled to the smart bases;
a centrally located server operably coupled to the interface module; and
at least one display unit coupled to the centrally located server.

11. The system according to claim 10, wherein the plurality of smart bases are deployed within a premise, the said premise selected from a list comprising of a departmental store, a warehouse, a local mart, a super mart and a hyper mart.

12. The system according to claim 10, wherein the smart base comprises of:
a top unit configured for replaceably holding at least one object; and
a bottom unit operably coupled to the top unit, wherein the bottom unit is configured for operating the smart base.

13. The system according to claim 12, wherein the object is selected from a list comprising of cosmetics, groceries, food items, stationary, house-hold items house-hold items, medicines, electronic appliances and industrial components.

14. The system according to claim 12, wherein the bottom unit comprises of a product location identifier;
a weight detection module; and
a communication module.

15. The system according to claim 12, wherein the bottom unit is further provided with a power module for charging and/or operating the smart base.

16. The system according to claim 14, wherein the product location identifier is configured for tracking the location of the smart base in real time.

17. The system according to claim 14, wherein the weight detection module comprises of at least one load cell for measuring the weight of the object placed on the top unit.

18. The system according to claim 14, wherein the communication module is configured for communicating a plurality of information selected from a list comprising of location of smart base, weight of the object on the smart base, location of object, battery level, time and date.

19. The system according to claim 10, wherein the interface module is configured for simultaneously receiving and transferring the information from the communication module of each of the smart bases.

20. The system according to claim 10, wherein the communication between each of the smart bases and the server is established through a wireless network, wherein the wireless network is at least one of a wi-fi network, a Bluetooth network or a near field communication network and/or a combination thereof.

21. The system according to claim 10, wherein the server is configured for processing the information received from the smart bases.

22. The system according to claim 10, wherein the server is further configured for sending an alert to at least one user when the quantity of objects held on the top unit falls below a threshold.

23. The system according to claim 22, wherein the user is selected from a list comprising of a customer, a vendor, a supplier, a store manager, an owner, a wholesaler and a stockist.

24. The system according to claim 10, wherein the display unit is accessible from at least one device selected from a list comprising of a mobile internet device, a computer, a smart phone, a notebook and a tablet.
